(19) United States
(12) Patent Application Publication
(10) Pub. No.: US 2026/0340137 A1
(43) Pub. Date: Oct. 29, 2026

(54) DETERMINATION DEVICE, DETERMINATION METHOD, AND DETERMINATION PROGRAM

(71) Applicant: NTT, Inc., Tokyo (JP)

(72) Inventors: Takuya WATANABE, Musashino-shi, Tokyo (JP); Mitsuaki AKIYAMA, Musashino-shi, Tokyo (JP); Eitaro SHIOJI, Musashino-shi, Tokyo (JP)

(73) Assignee: NTT, Inc., Tokyo (JP)

(21) Appl. No.: 19/110,120

(22) PCT Filed: Sep. 29, 2022
(86) PCT No.: PCT/JP2022/036585

§ 371 Date: Mar. 10, 2025

(51) Int. Cl. G06F 21/57; G06F 11/3668

(52) U.S. Cl. CPC G06F 21/577; G06F 11/3684; G06F 11/3688

(57) ABSTRACT

A determination device includes processing circuitry configured to create a test scenario including access to a web page for requesting, via a browser, an authority to acquire data from equipment provided in a device that executes the browser, cause the browser to execute the scenario, and determine presence or absence of a vulnerability of the web page or the browser on a basis of an execution result of the scenario.

### TECHNICAL FIELD

The present invention relates to a determination device, a determination method, and a determination program.

### BACKGROUND ART

In order to implement abundant content, there is a website linked with functions such as a camera, a microphone, and a global positioning system (GPS) of an execution device 20. Such a website provides services such as a map, video conferencing, and voice chat, for example.

Furthermore, when a website acquires privacy sensitive data such as location information, a camera image, and a microphone voice, the website requests permission from a user through a permission mechanism of a web browser (hereinafter, simply referred to as a browser). In addition, such an operation of a browser for requesting permission is referred to as a permission request or an authority request.

In a case where there is a vulnerability in the implementation of permission, access to and breach of privacy data not intended by the user may be performed.

Conventionally, a method for investigating a security problem of a browser is known (see, for example, Non Patent Literature 1 and Non Patent Literature 2).

### CITATION LIST

### Non Patent Literature

Non Patent Literature 1: Gertjan Franken et al. (2018 USENIX), Who Left Open the Cookie Jar? A ComprehensiveEvaluation of Third-Party Cookie Policies Non Patent Literature 2: Tales of Favicons and Caches: Persistent Tracking in Modern Browsers

### SUMMARY OF INVENTION

### Technical Problem

However, the conventional techniques have a problem that a vulnerability of a browser related to permission cannot be found in some cases.

For example, the technique described in Non Patent Literature 1 is to investigate a vulnerability related to Cookie. Furthermore, for example, the technique described in Non Patent Literature 2 is to investigate a vulnerability that a user is tracked with a favicon. As described above, the techniques described in Non Patent Literature 1 and Non Patent Literature 2 investigate security problems of a browser, but do not investigate a vulnerability related to permission.

### Solution to Problem

In order to solve the above-described problem and achieve an object, a determination device includes: a scenario creation unit that creates a test scenario including access to a web page for requesting, via a browser, an authority to acquire data from equipment provided in a device that executes the browser; an execution control unit that causes the browser to execute the scenario; and a determination unit that determines presence or absence of a vulnerability of the web page or the browser on a basis of an execution result of the scenario.

### Advantageous Effects of Invention

According to the present invention, a vulnerability of a browser related to permission can be found.

### BRIEF DESCRIPTION OF DRAWINGS

FIG. 1 is a diagram illustrating a configuration example of a determination device.

FIG. 2 is a diagram illustrating an example of a scenario.

FIG. 3 is a diagram illustrating an example of a scenario.

FIG. 4 is a diagram illustrating an example of a scenario.

FIG. 5 is a diagram illustrating an example of a scenario.

FIG. 6 is a diagram illustrating an example of a scenario.

FIG. 7 is a diagram illustrating an example of a scenario.

FIG. 8 is a flowchart illustrating a flow of processing of the determination device.

FIG. 9 is a diagram illustrating an example of a computer that executes a determination program.

### DESCRIPTION OF EMBODIMENTS

Hereinafter, an embodiment of a determination device, a determination method, and a determination program according to the present application will be described in detail with reference to the drawings. Note that the present invention is not limited to the embodiment described below.

### Configuration of First Embodiment

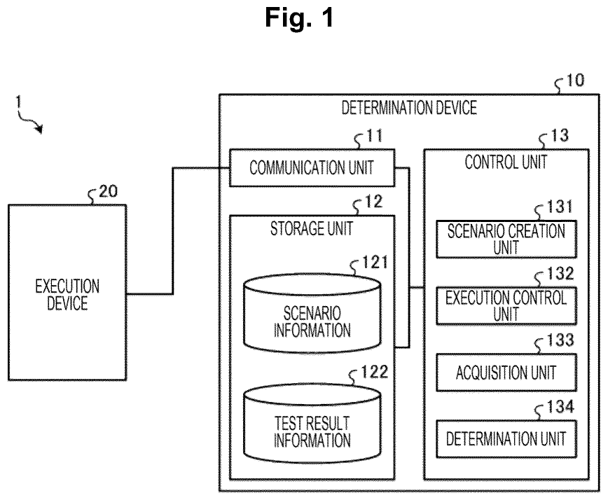

First, a configuration of an analysis system according to the first embodiment will be described with reference to FIG. 1. FIG. 1 is a diagram illustrating a configuration example of a determination device.

A determination device 10 creates a test scenario for investigating a permission vulnerability of a browser. The determination device 10 causes a browser of an execution device 20 to execute the scenario. In addition, the determination device 10 determines a vulnerability of the browser of the execution device 20. Note that, for example, the browser is Chrome (registered trademark), Firefox (registered trademark), Opera, Safari (registered trademark), or the like.

The execution device 20 functions as a host that provides a web page and a client that requests the web page.

As illustrated in FIG. 1, the determination device 10 includes a communication unit 11, a storage unit 12, and a control unit 13.

The communication unit 11 is an interface for transmitting and receiving data to and from other devices. For example, the communication unit 11 is a network interface card (NIC).

The storage unit 12 is a storage device such as a hard disk drive (HDD), a solid state drive (SSD), or an optical disk. Note that the storage unit 12 may be a semiconductor memory capable of rewriting data, such as a random access memory (RAM), a flash memory, or a nonvolatile static random access memory (NVSRAM).

The storage unit 12 stores data related to an operating system (OS) and various programs executed by the determination device 10. For example, the storage unit 12 stores scenario information 121 and test result information 122.

The scenario information 121 is a test scenario. Furthermore, the scenario information 121 may be information on unit tests, which are units constituting a test scenario. The unit tests are, for example, operations of a browser such as “accessing a specified web page”, “selecting permission of an authority”, “terminating a browser”, “starting (or restarting) a browser”, “accessing a linked web page”, “updating a page”, “inputting a specified character string into a text box”, and “pressing a button”.

The test result information 122 is test results collected from a group of execution devices 20. The test result information 122 may be a log of the execution device 20, data output as a test result by the execution device 20, or a screen capture of a browser.

The control unit 13 controls the entire determination device 10. The control unit 13 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA).

In addition, the control unit 13 includes an internal memory for storing programs defining various processing procedures and control data, and executes each type of processing using the internal memory. Furthermore, the control unit 13 functions as various processing units by various programs operating.

For example, the control unit 13 functions as a scenario creation unit 131, an execution control unit 132, an acquisition unit 133, and a determination unit 134.

The scenario creation unit 131 creates a test scenario including access to a web page for requesting, via a browser, an authority to acquire data from equipment provided in a device that executes the browser.

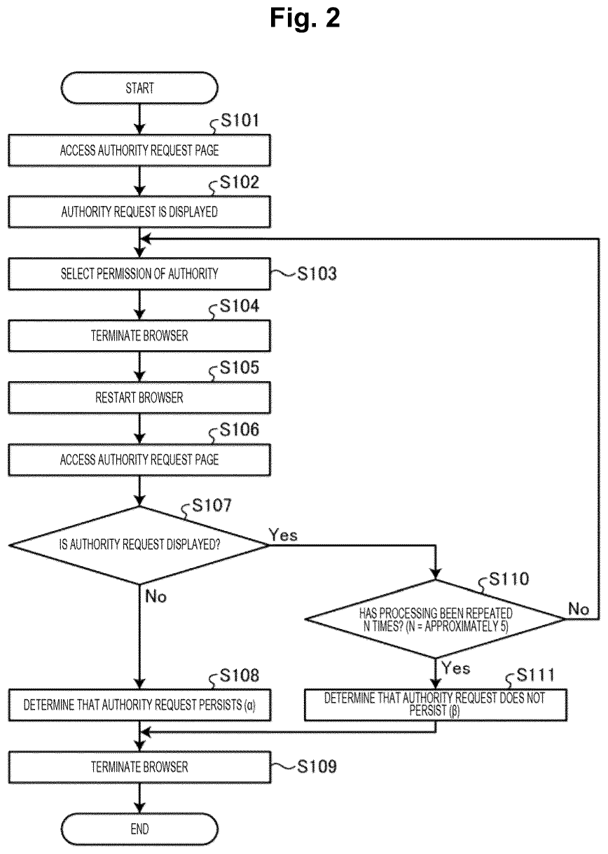

For example, the scenario creation unit 131 describes scenarios as illustrated in FIGS. 2, 3, 4, 5, 6, and 7. FIGS. 2, 3, 4, 5, 6, and 7 are diagrams illustrating examples of scenarios. Each scenario may be expressible by a flowchart as illustrated in FIG. 2 or the like. Details of each scenario will be described later.

The execution control unit 132 causes the browser of the execution device 20 to execute the scenario. The execution control unit 132 causes the execution device 20 to drive a code generated from the scenario by the scenario creation unit 131.

The acquisition unit 133 acquires a test result from the execution device 20. The test result is a log of the execution device 20, data output from the execution device 20, a screen capture of the browser, or the like.

The determination unit 134 determines the presence or absence of a vulnerability of the web page or the browser on the basis of an execution result of the scenario. The determination unit 134 makes a determination on the basis of the test result acquired by the acquisition unit 133.

Hereinafter, examples of scenarios will be described with reference to FIGS. 2, 3, 4, 5, 6, and 7. Each step of the flowcharts illustrated in the drawings corresponds to a unit test.

Furthermore, here, in each scenario, the execution device 20 outputs either “x” or “B”. The determination unit 134 determines a vulnerability on the basis of “x” or “B” acquired by the acquisition unit 133.

### First Scenario: Persistence of Authority Request Permission

FIG. 2 is a flowchart of the first scenario. From a result of the first scenario, the determination device 10 can determine the persistence of authority request permission.

The execution device 20 first accesses an authority request page (step S101). For example, the authority request page requests an authority to acquire information (camera image, position information, and the like) from the execution device 20 via a browser.

Next, an authority request is displayed on the authority request page on the browser of the execution device 20 (step S102). For example, the authority request is displayed as a pop-up screen including a message and a button for selecting permission or denial of the authority.

Here, the execution device 20 selects permission of the authority (step S103). For example, the execution device 20 performs an operation of pressing an “OK” button on the pop-up screen.

After terminating the browser (step S104), the execution device 20 restarts the browser (step S105).

Thereafter, the execution device 20 further accesses the authority request page (step S106).

Here, if the authority request is not displayed on the authority request page again after step S106 (step S107, No), the execution device 20 determines that the authority request persists, and outputs “x” (step S108).

On the other hand, if the authority request is displayed on the authority request page again after step S106 (step S107, Yes), the execution device 20 proceeds to step S110.

Here, if steps S103 to S106 have been repeated N times (for example, N=5) (step S110, Yes), the execution device 20 determines that the authority request does not persist, and outputs “B” (step S111).

If steps S103 to S106 have not been repeated N times (step S110, No), the execution device 20 returns to step S103 and repeats the processing.

After step S108 or step S111, the execution device 20 terminates the browser (step S109).

Note that the scenario creation unit 131 may create a scenario in which “selecting permission of the authority” in step S103 of the first scenario is replaced with “selecting denial of the authority”.

### Second Scenario: Automatic Permission or Denial of Authority Request

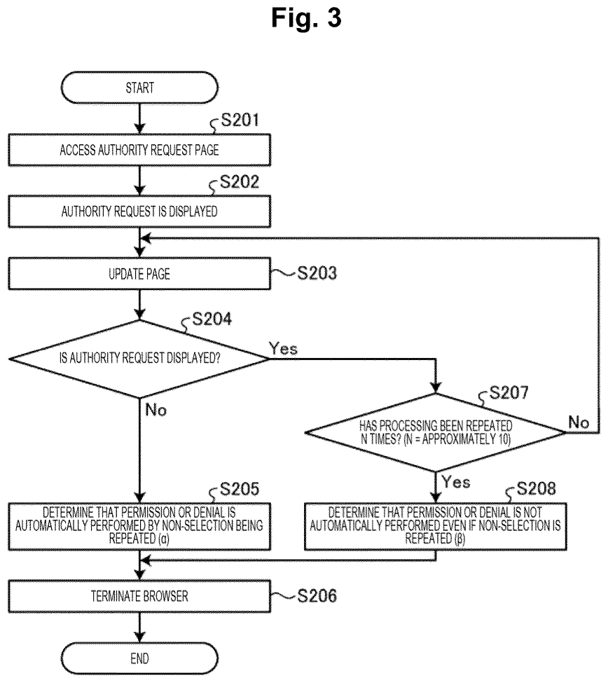

FIG. 3 is a flowchart of the second scenario. From a result of the second scenario, the determination device 10 can determine whether permission or denial (permission or denial) is automatically performed by non-selection being repeated with respect to an authority request.

The execution device 20 first accesses an authority request page (step S201). For example, the authority request page requests an authority to acquire information (camera image, position information, and the like) from the execution device 20 via a browser.

Next, an authority request is displayed on the authority request page on the browser of the execution device 20 (step S202). For example, the authority request is displayed as a pop-up screen including a message and a button for selecting permission or denial of the authority.

Here, the execution device 20 updates (refreshes) the page without selecting permission or denial of the authority (step S203).

Here, if the authority request is not displayed on the authority request page again after step S203 (step S204, No), the execution device 20 determines that permission or denial is automatically performed by the non-selection being repeated, and outputs “x” (step S205).

On the other hand, if the authority request is displayed on the authority request page again after step S203 (step S204, Yes), the execution device 20 proceeds to step S207.

Here, if step S203 has been repeated N times (for example, N=5) (step S207, Yes), the execution device 20 determines that permission or denial is not automatically performed even if the non-selection is repeated, and outputs “B” (step S208).

If step S203 has not been repeated N times (step S207, No), the execution device 20 returns to step S203 and repeats the processing.

After step S205 or step S208, the execution device 20 terminates the browser (step S206).

### Third Scenario: Automatic Permission or Denial of Authority Request (Background)

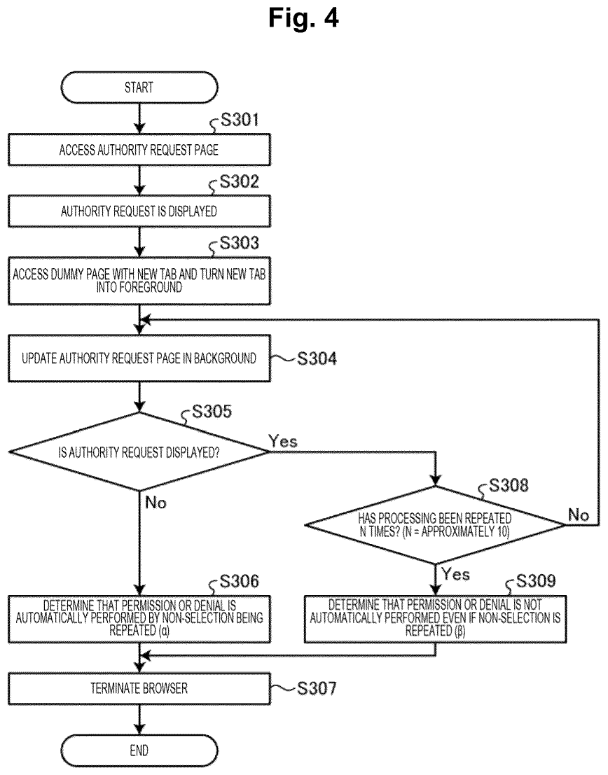

FIG. 4 is a flowchart of the third scenario. From a result of the third scenario, the determination device 10 can determine whether permission or denial (permission or denial) is automatically performed in the background by non-selection being repeated with respect to an authority request.

The execution device 20 first accesses an authority request page (step S301). For example, the authority request page requests an authority to acquire information (camera image, position information, and the like) from the execution device 20 via a browser.

Next, an authority request is displayed on the authority request page on the browser of the execution device 20 (step S302). For example, the authority request is displayed as a pop-up screen including a message and a button for selecting permission or denial of the authority.

Here, the execution device 20 accesses a dummy page with a new tab of the browser without selecting permission or denial of the authority, and turns the new tab into a foreground (step S303). The execution device 20 then updates (refreshes) the original page in the background (step S304).

Note that the dummy page is, for example, a page in which no authority request is made, and may be a blank page. The access to the dummy page may be performed in a mode different from that of the access to the authority request page or by a process different from that of the access to the authority request page.

Here, if the authority request is not displayed on the authority request page again after step S304 (step S305, No), the execution device 20 determines that permission or denial is automatically performed by the non-selection being repeated, and outputs “x” (step S306).

On the other hand, if the authority request is displayed on the authority request page again after step S304 (step S305, Yes), the execution device 20 proceeds to step S308.

Here, if step S304 has been repeated N times (for example, N=5) (step S308, Yes), the execution device 20 determines that permission or denial is not automatically performed even if the non-selection is repeated, and outputs “B” (step S309).

If step S304 has not been repeated N times (step S308, No), the execution device 20 returns to step S304 and repeats the processing.

After step S306 or step S309, the execution device 20 terminates the browser (step S307).

As described above, the scenario creation unit 131 creates a scenario (first scenario) in which, after permission or denial is selected for an authority request from a web page accessed by a browser, the browser is restarted and the web page is accessed again.

In addition, the scenario creation unit 131 creates a scenario (second scenario) in which, after an authority request from a web page accessed by a browser is displayed, the web page is updated.

In addition, the scenario creation unit 131 creates a scenario (third scenario) in which, after an authority request from a web page accessed by a browser is displayed, the web page is updated in a state where the web page is set in the background.

If the outputs of the first scenario and the second scenario or the outputs of the first scenario and the third scenario are “x”, an attacker can force the authority permission/denial state (state of permission or denial) without user operation and make the state persistent, and can further track a user who has visited the web page without using Cookie or the like by checking the authority permission/denial state when the user revisits the web page.

The determination device 10 can determine the vulnerability as described above according to the first scenario, the second scenario, and the third scenario.

### Fourth Scenario: Inter-Mode Takeover of Authority Request Permission (Private to Normal)

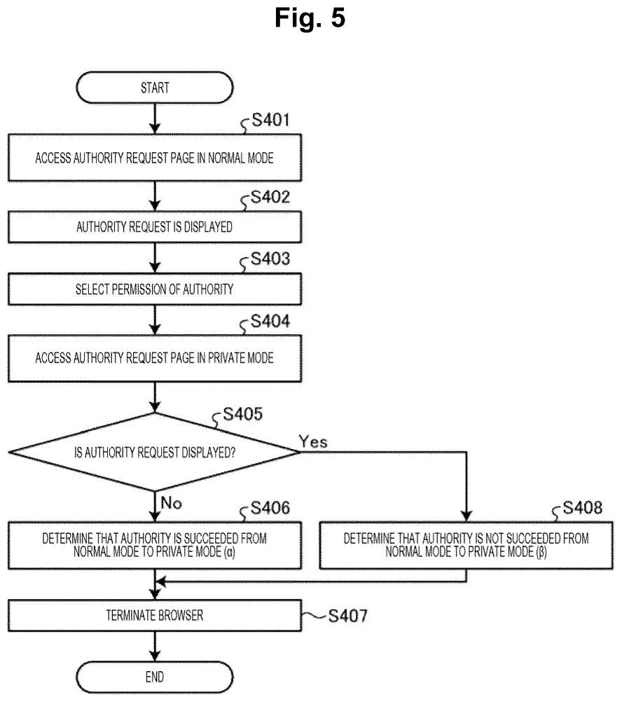

FIG. 5 is a flowchart of the fourth scenario. From a result of the fourth scenario, the determination device 10 can determine whether an authority (permission for an authority request) is taken over from a private mode to a normal mode. Note that the private mode is a mode in which so-called private browsing is performed, and is a mode in which a browsing history or the like, which is saved in the normal mode, is not saved.

The execution device 20 first accesses an authority request page in the normal mode (step S401). For example, the authority request page requests an authority to acquire information (camera image, position information, and the like) from the execution device 20 via a browser.

Next, an authority request is displayed on the authority request page on the browser of the execution device 20 (step S402). For example, the authority request is displayed as a pop-up screen including a message and a button for selecting permission or denial of the authority.

Furthermore, if permission of the authority is selected (step S403), the execution device 20 accesses the authority request page in the private mode (step S404).

Here, if the authority request is not displayed on the authority request page again after step S404 (step S405, No), the execution device 20 determines that the authority is succeeded in the transition from the normal mode to the private mode, and outputs “x” (step S406).

On the other hand, if the authority request is displayed on the authority request page again after step S404 (step S405, Yes), the execution device 20 determines that the authority is not succeeded in the transition from the normal mode to the private mode, and outputs “B” (step S408).

After step S406 or step S408, the execution device 20 terminates the browser (step S407).

### Fifth Scenario: Inter-Mode Takeover of Authority Request permission (Private to Normal)

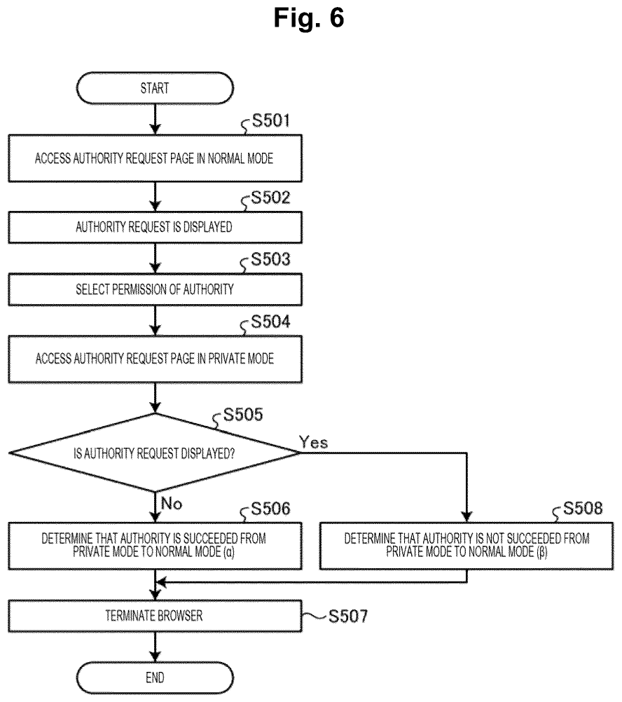

FIG. 6 is a flowchart of the fifth scenario. From a result of the fifth scenario, the determination device 10 can determine whether an authority (permission for an authority request) is succeeded from the normal mode to the private mode.

The execution device 20 first accesses an authority request page in the normal mode (step S501). For example, the authority request page requests an authority to acquire information (camera image, position information, and the like) from the execution device 20 via a browser.

Next, an authority request is displayed on the authority request page on the browser of the execution device 20 (step S502). For example, the authority request is displayed as a pop-up screen including a message and a button for selecting permission or denial of the authority.

The execution device 20 selects permission of the authority (step S503). For example, the execution device 20 performs an operation of pressing an “OK” button on the pop-up screen.

Furthermore, the execution device 20 accesses the authority request page in the private mode (step S504).

Here, if the authority request is not displayed on the authority request page again after step S504 (step S505, No), the execution device 20 determines that the authority is succeeded in the transition from the normal mode to the private mode, and outputs “x” (step $506).

On the other hand, if the authority request is displayed on the authority request page again after step S504 (step S505, Yes), the execution device 20 determines that the authority is not succeeded in the transition from the normal mode to the private mode, and outputs “B” (step S508).

After step S506 or step S508, the execution device 20 terminates the browser (step S507).

Note that the scenario creation unit 131 may create a scenario in which “selecting permission of the authority” in step S503 of the fifth scenario is replaced with “selecting denial of the authority”.

As described above, the scenario creation unit 131 creates a scenario (the fourth scenario and the fifth scenario) in which, after permission or denial is selected for an authority request from a web page accessed by a browser in the first mode, the browser is changed to the second mode and the web page is accessed again.

In a case where the output of the fourth scenario or the fifth scenario is “x”, the authority permission/denial state is shared between the normal mode and the private mode, and it is not possible to use the browser in a state where user-specific information is concealed.

The determination device 10 can determine the vulnerability as described above according to the fourth scenario and the fifth scenario.

### Sixth Scenario: Overlay Display of Authority Request

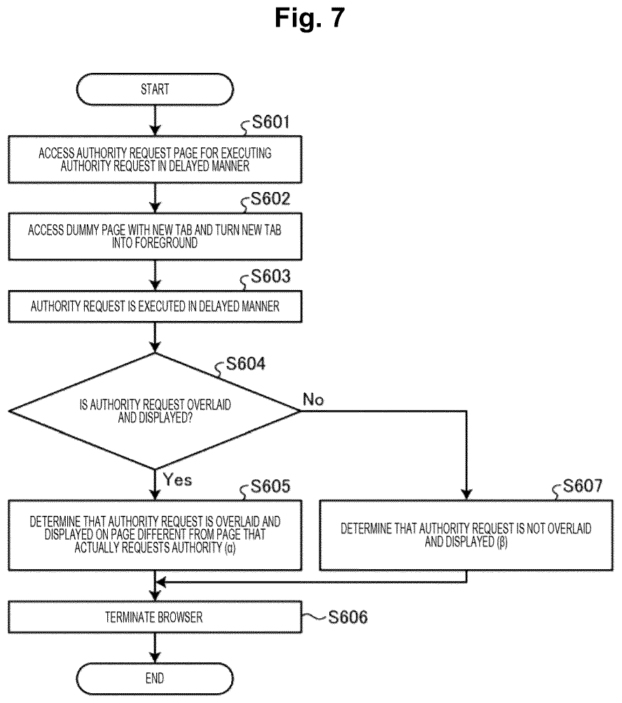

FIG. 7 is a flowchart of the sixth scenario. From a result of the sixth scenario, the determination device 10 can determine whether an authority request is overlaid and displayed on a page different from a page that actually requests an authority.

The execution device 20 first accesses an authority request page that executes an authority request in a delayed manner (step S601). For example, the authority request page requests an authority to acquire information (camera image, position information, and the like) from the execution device 20 via a browser. In addition, in the authority request page that executes the authority request in a delayed manner, the authority request is displayed after a certain period of time elapses after the content of the web page is displayed.

Next, the execution device 20 accesses a dummy page with a new tab of the browser and turns the new tab into a foreground (step S602). Thereafter, the execution device 20 waits until the authority request is executed in a delayed manner on the original page in the background (step S603).

Note that the dummy page is, for example, a page in which no authority request is made, and may be a blank page. The access to the dummy page may be performed in a mode different from that of the access to the authority request page or by a process different from that of the access to the authority request page.

Here, if the authority request is overlaid and displayed manner after step S603 (step S604, Yes), the execution device 20 determines that the authority request is overlaid and displayed on a page different from the page that actually requests the authority, and outputs “x” (step S605).

Note that, in the case where step S604 is Yes, the authority request is overlaid and displayed on the new tab set in the foreground.

On the other hand, if the authority request is not overlaid and displayed after step S603 (step S604, No), the execution device 20 determines that the authority request is not overlaid and displayed, and outputs “B” (step S607). Note that the case where No in step S604 includes a case where the authority request is not displayed even after a certain period of time has elapsed and a case where the authority request is displayed in the background and does not appear on the screen.

As described above, the scenario creation unit 131 creates a scenario (sixth scenario) in which a web page accessed by a browser is turned into the background before an authority request from the web page is displayed.

When the output of the sixth scenario is “x”, the authority request from the web page, which is different from a page displayed to a user, is overlaid and displayed, and a permission destination recognized by the user and an actual permission destination may be different.

The determination device 10 can determine the vulnerability as described above according to the sixth scenario.

### Flow of Processing of First Embodiment

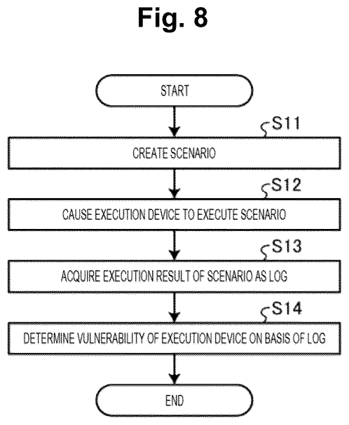

A flow of processing of the determination device 10 will be described with reference to FIG. 8. FIG. 8 is a flowchart illustrating the flow of processing of the determination device.

As illustrated in FIG. 8, first, the determination device 10 creates a scenario (step S11). Next, the determination device 10 causes the execution device to execute the scenario (step S12).

The determination device 10 acquires an execution result of the scenario as a log (step S13). The determination device 10 then determines a vulnerability of the execution device on the basis of the log (step S14).

### Effects of First Embodiment

As described above, the determination device 10 includes the scenario creation unit 131, the execution control unit 132, and the determination unit 134. The scenario creation unit 131 creates a test scenario including access to a web page for requesting, via a browser, an authority to acquire data from equipment provided in a device that executes the browser. The execution control unit 132 causes the browser of the execution device 20 to execute the scenario. The determination unit 134 determines the presence or absence of a vulnerability of the web page or the browser on the basis of an execution result of the scenario. According to the first embodiment, a vulnerability of a browser related to permission can be found.

### System Configuration and Others

Furthermore, each component of the illustrated devices is functionally conceptual, and does not necessarily need to be physically configured as illustrated. That is, a specific form of distribution and integration of the devices is not limited to the illustrated form, and all or a part thereof can be functionally or physically distributed or integrated in any unit according to various loads, usage conditions, and the like. Furthermore, all or some of the respective processing functions performed in the devices may be implemented by a central processing unit (CPU) and a program analyzed and executed by the CPU or may be implemented as hardware by wired logic. Note that the program may be executed not only by the CPU but also by another processor such as a GPU.

In addition, among the processing described in the present embodiment, all or some of the processing described as being automatically performed can be manually performed, or all or some of the processing described as being manually performed can be automatically performed by a known method. In addition, the processing procedures, the control procedures, the specific names, and the information including various kinds of data and parameters illustrated in the above document and drawings can be arbitrarily changed unless otherwise specified.

### Program

As an embodiment, the determination device 10 can be implemented by installing a determination program for executing the above determination processing as package software or online software in a desired computer. For example, causing an information processing device to execute the above determination program enables the information processing device to function as the determination device 10. The information processing device mentioned here includes a desktop or laptop personal computer. In addition, the information processing device also includes a mobile communication terminal such as a smartphone, a mobile phone, or a personal handy-phone system (PHS), a slate terminal such as a personal digital assistant (PDA), and the like.

Furthermore, when the execution device 20 used by a user is implemented as a client, the determination device 10 can also be implemented as a determination server device that provides the client with a service related to the above determination processing. For example, the determination server device is implemented as a server device that provides a determination service in which an authority request page is input and a determination result is output. In this case, the determination server device may be implemented as a web server or may be implemented as a cloud that provides a service related to the above determination processing by outsourcing.

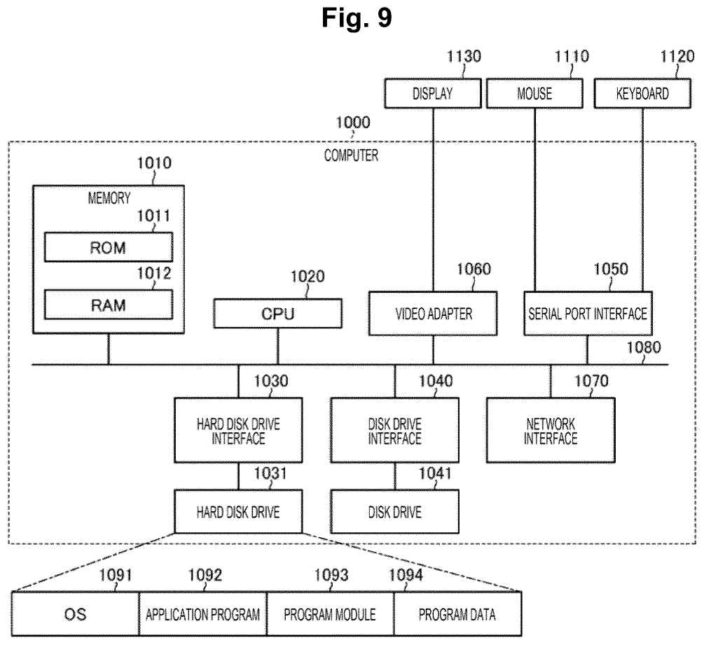

FIG. 9 is a diagram illustrating an example of a computer that executes the determination program. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disk is inserted into the disk drive 1041.

The serial port interface 1050 is connected to, for example, a mouse 1110 and a keyboard 1120. The video adapter 1060 is connected to, for example, a display 1130.

The hard disk drive 1031 stores, for example, an OS 1091, an application program 1092, a program module 1093, and program data 1094. That is, a program that defines each type of processing of the determination device 10 is implemented as the program module 1093 in which a code executable by a computer is described. The program module 1093 is stored in, for example, the hard disk drive 1031.

For example, the program module 1093 for executing processing similar to the functional configuration in the determination device 10 is stored in the hard disk drive 1031. Note that the hard disk drive 1031 may be replaced with an SSD.

In addition, setting data used in the processing of the above-described embodiment is stored, for example, in the memory 1010 or the hard disk drive 1031 as the program data 1094. The CPU 1020 then reads the program module 1093 and the program data 1094 stored in the memory 1010 or the hard disk drive 1031 to the RAM 1012 as necessary, and executes the processing of the above-described embodiment.

Note that the program module 1093 and the program data 1094 are not limited to being stored in the hard disk drive 1031, and may be stored in, for example, a removable storage medium and read by the CPU 1020 via the disk drive 1041 or the like. Alternatively, the program module 1093 and the program data 1094 may be stored in another computer connected via a network (local area network (LAN), wide area network (WAN), or the like). The program module 1093 and the program data 1094 may be read by the CPU 1020 from another computer via the network interface 1070.

### REFERENCE SIGNS LIST

10 Determination device
11 Communication unit
12 Storage unit
13 Control unit
20 Execution device
121 Scenario information
122 Test result information
131 Scenario creation unit
132 Execution control unit
133 Acquisition unit
134 Determination unit

1. A determination device comprising:
processing circuitry configured to:
create a test scenario including access to a web page for requesting, via a browser, an authority to acquire data from equipment provided in a device that executes the browser;
cause the browser to execute the scenario; and
determine presence or absence of a vulnerability of the web page or the browser on a basis of an execution result of the scenario.

2. The determination device according to claim 1, wherein the processing circuitry is further configured to create a scenario in which, after permission or denial is selected for an authority request from a web page accessed by a browser, the browser is restarted and the web page is accessed again.

3. The determination device according to claim 1, wherein the processing circuitry is further configured to create a scenario in which, after an authority request from a web page accessed by a browser is displayed, the web page is updated.

4. The determination device according to claim 1, wherein the processing circuitry is further configured to create a scenario in which, after an authority request from a web page accessed by a browser is displayed, the web page is updated in a state where the web page is set in a background.

5. The determination device according to claim 1, wherein the processing circuitry is further configured to create a scenario in which, after permission or denial is selected for an authority request from a web page accessed by a browser in a first mode, the browser is changed to a second mode and the web page is accessed again.

6. The determination device according to claim 1, wherein the processing circuitry is further configured to create a scenario in which a web page accessed by a browser is turned into a background before an authority request from the web page is displayed.

7. A determination method, comprising:
creating a test scenario including access to a web page for requesting, via a browser, an authority to acquire data from equipment provided in a device that executes the browser;
causing the browser to execute the scenario; and
determining presence or absence of a vulnerability of the web page or the browser on a basis of an execution result of the scenario.

8. A non-transitory computer-readable recording medium storing therein a determination program that causes a computer to execute a process comprising:
creating a test scenario including access to a web page for requesting, via a browser, an authority to acquire data from equipment provided in a device that executes the browser;
causing the browser to execute the scenario; and
determining presence or absence of a vulnerability of the web page or the browser on a basis of an execution result of the scenario.
